(19) United States
(12) Patent Application Publication
(10) Pub. No.: US 2014/0148368 A1
(43) Pub. Date: May 29, 2014

(54) DRILLING FLUIDS AND DRILLING FLUID ADDITIVES FOR TREATMENT OF BITUMEN IN WELLBORE CUTTINGS

(71) Applicant: Marquis Alliance Energy Group Inc., Calgary (CA)

(72) Inventors: Kuangbiao MA, Calgary (CA); Stuart DUBBERLEY, Calgary (CA)

(73) Assignee: Marquis Alliance Energy Group Inc., Calgary (CA)

(21) Appl. No.: 14/067,976

(22) Filed: Oct. 31, 2013

Related U.S. Application Data
(60) Provisional application No. 61/729,450, filed on Nov. 23, 2012.

(51) Int. Cl. C09K 8/12

(52) U.S. Cl. CPC C09K 8/12
USPC 507/138

(57) ABSTRACT

Aqueous drilling fluid compositions include one or more di-functional carboxylic acids in addition to common drilling fluid constituents such as viscosifiers, fluid loss control additives, weighting materials, and other materials. In certain embodiments, the one or more di-functional carboxylic acids comprise dodecanedioic acid. Such drilling fluid compositions are particularly beneficial for use in drilling operations in bitumen-laden formations such as oil sands, where the drill cuttings will introduce significant amounts of bitumen into the drilling fluid. The inclusion of the di-functional carboxylic acids, in suitable concentrations, reduces the tendency of bitumen to adhere to metal surfaces such as drill string components, and enhances wellbore integrity and stability.

### FIELD

The present disclosure relates in general to drilling fluids (or “drilling muds”) for use in drilling oil and gas wells, and relates in particular to water-based drilling fluids for use in drilling wells in bitumen-laden subsurface formations.

### BACKGROUND

Oil and gas wells are most commonly drilled using the rotary drilling method. In these methods, a drill bit with fixed or rotatable cutting teeth is mounted at the lower end of a drill string comprising a linear assembly of drill pipe, drill collars, and other drilling accessories incorporated into a bottomhole assembly (“BHA”). The drill string is rotatable by means of either a rotary table or a top drive apparatus associated with the drilling rig. In some cases, such as when drilling deviated or “directional” wellbores, the drill string is rotated by a downhole motor (commonly referred to as a mud motor) incorporated into the drill string close to the drill bit. Whatever means of rotation is used, the rotation of the drill string causes the drill bit to bore into the ground. Additional sections of drill pipe are added to the drill string as the well is drilled deeper, until the desired wellbore depth is reached. The cutting diameter of the drill bit is larger than the diameter of the drill string components, such that the drilling operation creates an annular space (or “wellbore annulus”) between the drill string and the sides of the wellbore.

During drilling operations, a slurry mixture called drilling fluid (commonly referred to as “drilling mud”) is circulated continuously down through the drill string, out the bottom of the drill string and then back to the surface through the wellbore annulus.

Drilling mud serves a number of functions, one of the most important of which is to carry material cut through by the drill bit (commonly called “cuttings”) out of the wellbore and up to the surface, so that the cuttings do not clog the wellbore and impede further drilling. In a typical drilling operation, the drilling mud returning to surface from the wellbore is processed through cleaning equipment (typically including a “shale shaker” associated with the drilling rig) to separate cuttings from the drilling fluid so that the cuttings can be suitably processed and disposed of, and so that the drilling fluid can be cleaned and conditioned for re-use in drilling operations.

For wells drilled into oil sands formations (such as the Athabasca oil sands in Alberta, Canada), the drilling fluid returning to surface typically contain significant amounts of bitumen, as free masses or agglomerated with sand. This bitumen adheres to metal surfaces such as on drill string components, necessitating costly equipment cleaning procedures. For these reasons, there is a need for drilling fluid formulations that deter or minimize adhesion of bitumen to metal surfaces. Such formulations preferably would promote this objective without inducing any significant breakdown of the bitumen or of bitumen-sand agglomerations (which breakdown could make removal of bitumen and cuttings from the drilling fluid more difficult).

### BRIEF SUMMARY

In general terms, the present disclosure teaches aqueous drilling fluid compositions which include one or more di-functional carboxylic acids in addition to typical or common drilling fluid constituents such as viscosifiers, fluid loss control additives, weighting materials, and other materials. In certain embodiments, the one or more di-functional carboxylic acids comprise dodecanedioic acid (alternatively referred to herein as DDDA). Such drilling fluid compositions are particularly beneficial for drilling operations in bitumen-laden formations such as oil sands, where the drill cuttings will introduce significant amounts of bitumen into the drilling fluid. The inclusion of the di-functional carboxylic acids, in suitable concentrations, reduces the tendency of bitumen in oil sands formations to adhere to metal surfaces (such as drill string components), and enhances wellbore integrity and stability.

### BRIEF DESCRIPTION OF THE DRAWING

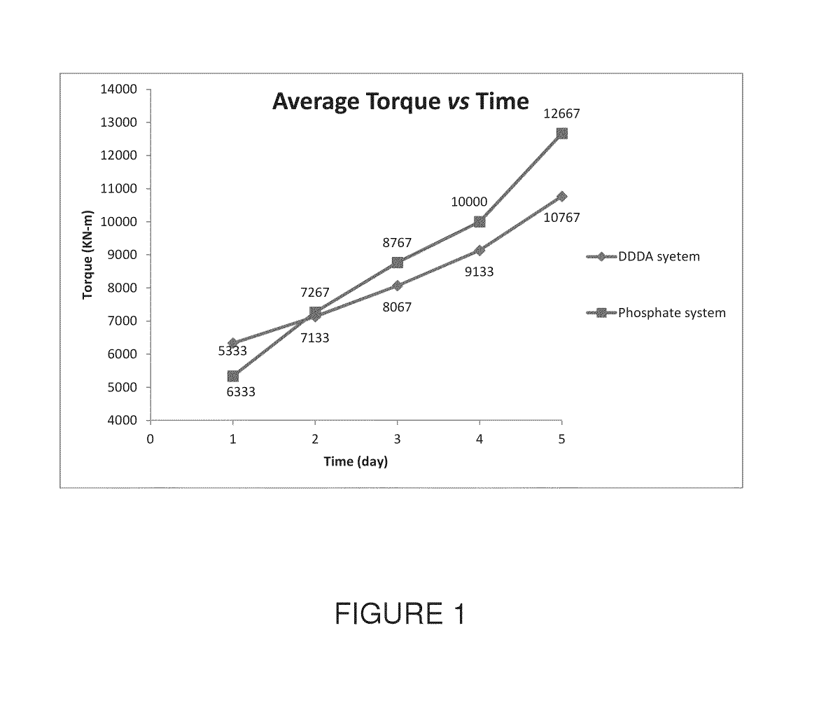

Embodiments in accordance with the present disclosure will now be described with reference to the accompanying FIG. 1, which is a comparative graph of drilling torque readings versus time as measured during field tests in which a first set of wells were drilled through an oil sands formation using aqueous drilling fluids incorporating dodecanedioic acid as an anti-accretion additive in accordance with the present disclosure, and a second set of similar wells were drilled using aqueous drilling fluids incorporating phosphate ester as an anti-accretion additive in accordance with prior art technology.

### DETAILED DESCRIPTION

It is known that di-functional carboxylic acids can dissolve in bitumen and that the dissolved di-functional carboxylic acid can self-assemble into a fibrous network within the bitumen. The range of temperatures through which bitumen remains a solid increases after incorporation of di-functional carboxylic acid into the bitumen, without influencing the melt viscosity of the bitumen. Moreover, bitumen's hardness and elastic modulus at room temperature are also improved due to the formation of fibers within the bitumen, as previously noted. It is believed that this modification of bitumen properties may be the mechanism giving rise to enhanced wellbore stability that has been empirically observed in field tests using drilling muds incorporating a di-functional carboxylic acid.

Drilling muds in accordance with the present disclosure include water and additives such as, for example, viscosifiers, fluid loss control additives, and weighting materials, along with at least one di-functional carboxylic acid as a bitumen anti-accretion and wellbore-strengthening additive.

The effective concentration or dosage of di-functional carboxylic acids as a drilling fluid additive in accordance with the present disclosure may be from 0.1% to 10% by weight of the fluid. The most effective dosage or range of dosages may vary according to bitumen properties as well as the properties of the particular di-functional carboxylic acid or acids being used. However, concentrations in the range of 0.25% to 3% by weight will generally be preferable, to balance functional effectiveness and economic considerations (i.e., costs of the additives).

Examples of the family of di-functional carboxylic acids that may be effective when used as drilling additives in accordance with the present disclosure include, but are not limited to, the diacids of intermediate length: butanedioic (succinic) acid, pentanedioic (glutaric) acid, hexanedioic (adipic) acid, heptanedioic (pimelic) acid, octanedioic (suberic) acid, nonanedioic (azelaic) acid, decanedioic (sebacic) acid, undecanedioic acid, dodecanedioic acid, tridecanedioic (brassylic acid), tetradecanedioic acid, pentadecanedioic acid, and hexadecanedioic (thapsic) acid.

Combinations of two or more diacids may also be effective. If two or more diacids have different chain length, they may have different dissolving rates in bitumen. However, after dissolving/mixing with bitumen, they will also form fibrous network, as in the case of formulations using a single diacid.

Di-functional carboxylic acids suitable for use as drilling additives in accordance with the present disclosure may be provided in powder form, with particle sizes ranging from 1.0 to 2000 μm, preferably with a median particle size of approximately 100 μm.

Di-functional carboxylic acids are only slightly soluble in water, and most of them are weak acids. For example, the solubility of dodecanedioic acid in water is 0.04 grams per liter (g/L) at 20° C. The acid dissociation constants pKₐ₁ and pKₐ₂ of dodecanedioic acid are 5.7 and 6.6 respectively, so there are no corrosion issues. In fact, in the concentration ranges set out above, such a di-functional carboxylic acid functions as an effective corrosion inhibitor.

Tests conducted by the inventors have indicated that dodecanedioic acid is compatible with other common additives in aqueous drilling fluid compositions; i.e., it appears to have minimal influence on the effectiveness of such other additives, and its effectiveness is minimally influenced by the present of such other additives. This compatibility is believed to be due to the low solubility of dodecanedioic acid.

At basic condition, the solubility of di-functional carboxylic acids in water increases. Accordingly, the preferred pH for drilling fluids in accordance with the present disclosure is 8.0 or less.

In addition to providing anti-accretion and wellbore-strengthening properties as previously described, such di-functional carboxylic acids also function as effective lubricants when incorporated into drilling fluid formulations.

The concentration of di-functional carboxylic acids in drilling fluids in accordance with the present disclosure may be monitored by conventional spectroscopic, chromatographic, and/or gravimetric methods, and by chemical titration as well.

### LABORATORY TESTING

Test Program #1

The solubility of dodecanedioic acid powder in bitumen was proven in laboratory experiments in which a 30-gram bitumen core sample was compressed at 1,000 pounds per square inch using a compactor, to make bitumen wafers having a diameter of 2.75 cm and a depth (thickness) of 1.8 cm. The bitumen wafer was rolled over carefully in a container with a sufficient quantity of dodecanedioic acid powder. The surface of bitumen wafer was covered with a thin layer of the dodecanedioic acid powder, and the color of the bitumen turned from black to white. After standing at ambient temperature for 24 hours, the bitumen wafer was visually inspected and the color of the bitumen wafer was observed to have turned black again, with a few white particles on the surface. After staying at ambient (i.e., room) temperature for 3 days, all of the white dodecanedioic acid powder had disappeared, demonstrating the solubility of di-functional carboxylic acid in bitumen.

Test Program #2

A second series of laboratory tests were conducted using a test procedure developed to replicate the stickiness of the bitumen onto a metal surface. In this test procedure, 300-mL samples of an aqueous drilling fluid were combined with 100 grams of broken-up bitumen core and a metal test rod in an OFITE® rolling cell (an apparatus familiar to persons skilled in the art). The rolling cell was then rolled for 16 hours at 35-38° C., and the metal test rod and the internal wall of the rolling cell were inspected for bitumen accretion. The mass of the metal rod was also determined both with any accretion of bitumen and after the accreted bitumen had been cleaned off. The results of these tests are set out in Table 1 below:

TABLE 1

| | Sample 1 | Sample 2 |
|---|---|---|
| Water (g) | 300 | 300 |
| MF Vis (g) | 0.3 | 0.3 |
| MF PAC R (g) | 1.2 | 1.2 |
| MF STAR (g) | 1.5 | 1.5 |
| Dodecanedioic acid (g) | 0 | 3.0 |
| Bitumen (g) | 100 | 100 |
| Mass of accreted bitumen (g) | 51.6 | 0.7 |
| OBSERVATIONS | Bitumen sticking | Bitumen not |
| | to metal rod | sticking to metal |
| | severely; the color | test rod, wall of |
| | of the mud is | roller cell, or the |
| | brown; some free | lid; the color of |
| | bitumen | mud is pale |
| | separated from | brown; no |
| | sands. | bitumen/sand |
| | | separation. |

In Table 1:
MF Vis ™ is a brand name of xanthan gum used as a drilling additive to provide viscosity in water-based mud.
MF PAC ™ is a brand name of a treated natural cellulose used to control fluid loss.
MF Star ™ is a brand name of starch used as a drilling additive used to control fluid loss.

Table 1 illustrates a dramatic decrease in the amounted of bitumen accretion onto the metal rod when the drilling fluid sample contained 3 grams of dodecanedioic acid, as compared to the case where the drilling fluid contained no dodecanedioic acid (with all other aspects of the drilling fluid composition being the same in both cases).

Test Program #3

In a third series of laboratory tests, bitumen wafers (prepared as in Test Program #1) were aged in glass jars filled with drilling fluids of different compositions. The integrity of the wafers was inspected from time to time, and the testing results are set out in Table 2 below:

TABLE 2

| | Sample 1 | Sample 2 | Sample 3 | Sample 4 |
|---|---|---|---|---|
| Water (g) | 300 | 300 | 300 | 300 |
| MF vis (g) | 0.3 | 0.3 | 0.3 | 0.3 |
| MF PAC R (g) | 1.2 | 1.2 | 1.2 | 1.2 |
| MF STAR (g) | 1.5 | 1.5 | 1.5 | 1.5 |
| Dodecanedioic | 3.0 | 0 | 0 | 0 |
| acid (g) | | | | |
| PHPA | 0 | 1.2 | 0 | 0 |
| Encapsulator | | | | |
| (g) | | | | |
| Phosphate | 0 | 0 | 3.0 | 0 |
| ester (g) | | | | |
| OBSER- | Bitumen | Bitumen | Bitumen | Bitumen |
| VATIONS | wafer intact | wafer broke | wafer broke | wafer broke |
| | after 2 | into pieces | into pieces | into pieces |
| | months | after 9 days | after 4 days | after 6 days |
| | soaking | soaking | soaking | soaking |

In Table 2:
PHPA denotes a non-ionic partially hydrolyzed polyacrylamide which has been used in the oil and gas drilling industry as a drilling mud additive for reducing bitumen accretion.
Phosphate ester is another drilling mud additive that has been used for reducing bitumen accretion.

Table 2 illustrates that the physical integrity of bitumen soaked in an aqueous drilling fluid containing dodecanedioic acid will be preserved far longer than for bitumen soaked in otherwise identical drilling fluids containing PHPA or phosphate ester instead of dodecanedioic acid. Maintenance of the physical integrity of the bitumen is desirable and beneficial for strengthening the wellbore and preventing washout (which could result in the well getting larger in diameter or collapsing).

Test Program #4

In a fourth series of laboratory tests, different concentrations of dodecanedioic acid were added into drilling fluids compositions formulated as in Sample 4 in Table 2 above, and the coefficient of friction of the fluids was determined using a standard Fann® EP/lubricity tester. During each test, a hardened steel block and a steel ring were placed in contact with each other in the presence of the drilling fluid to be tested. A gauge reading of 150 inch-pounds (corresponding to a pressure of 5,000 to 10,000 PSI) was applied between the block and the ring, and the ring was rotated at 60 RPM. All of the tested drilling fluids were run under these conditions; accordingly, the measured values for the coefficient of friction are directly comparable to each other. The testing results are shown in Table 3 below:

TABLE 3

| | Sample 1 | Sample 2 | Sample 3 |
|---|---|---|---|
| Water (g) | 300 | 300 | 300 |
| MF vis (g) | 0.3 | 0.3 | 0.3 |
| MF PAC R (g) | 1.2 | 1.2 | 1.2 |
| MF STAR (g) | 1.5 | 1.5 | 1.5 |
| Dodecanedioic acid (g) | 0 | 3.0 | 9.0 |
| Coefficient of Friction | 0.301 | 0.239 | 0.130 |

These test results indicate a significant and beneficial decrease in the coefficient of friction of drilling fluids treated with dodecanedioic acid, with higher concentrations of dodecanedioic acid resulting in greater decreases in the coefficient of friction. Lubricant usually needs to be used, especially for drilling long horizontal wells, to reduce torque and drag between drill string and wellbore. The lower coefficient of friction, the more lubricious the fluids are. Accordingly, the reduced coefficient of friction resulting from the introduction of dodecanedioic acid into the drilling mud, as indicated in Table 3, leads to reduced torque and drag, thus making drilling operations easier.

Drilling fluids in accordance with the present disclosure have been tested in the field, and the data collected from field tests in particular demonstrate the advantageous performance of drilling fluid formulations using dodecanedioic acid as an additive, and methods of using such formulations. In the field testing, bitumen accretion to the BHA/drill string has been limited, which results in the lower torque and drag. The drilling fluid system performed well, with no problems experienced on solid control equipment, and slotted liner was successfully pushed through horizontal wellbore sections.

In one field test, an operator drilled several horizontal well pairs (for a steam-assisted gravity drainage, or “SAGD” well installation) in a projected area containing oil sands ranging from 20 to 58 meters in thickness with high porosity (30-35%), permeability (3-10 D), and 70-85% bitumen saturation. The well characteristics are listed below:
Total well depth: 1531-1602 m
Bit size: 222 mm
Liner I.D.: 159.4mm
Liner 0.D.: 177.8 mm
Rig shaker screen size: 89
Complex shaker screen size: 120

Typical drilling fluid (mud) properties were as follows:
Mud density: 1040-1075 kg/m3
pH=6.5-8.0
Flow line temperature: 23-32° C.
Oil content in mud: 0.5-1% from retort analysis
Solids content: 2.6-4.9

Dodecanedioic acid (DDDA) was added at a rate of around one to two 11.34 kg sacks per hour, with the DDDA content in the drilling fluid being kept at 3.5 to 6.6 kg/m3 during the drilling period. No shaker screen blinding or transferring of fluid from the rig to the complex were experienced. Horizontal slotted liners were run and set with no problems; plugs were also set in the liners with no problems.

In another series of field tests, ten horizontal wells were drilled with a polymer drilling mud, in relatively close proximity to each other such that geological variations between the wells were minimized. Five wells used DDDA as an anti-accretion additive in the drilling mud, while the offset wells used phosphate ester as an anti-accretion additive, thus enabling a direct field comparison of the performance of the two fluids. The operator monitored the torque and drag constantly for all wells, and torque and drag readings were recorded roughly at the same time interval every day during the drilling period. The average torque of the five wells using DDDA was calculated, as were the average torques for the five offset wells using phosphate ester. The results are illustrated in FIG. 1.

The wells using DDDA drilling fluid systems started with a bigger turn than the wells using phosphate ester (due to differences in well geometries), so the initial torque was higher for the DDDA wells than for the comparison wells. However, drilling progressed, the torque recorded with the DDDA system showed lower rate of increase than for the comparison wells. This favorable comparison can be attributed to less bitumen accreting on the drill string/BHA assembly due to the use of DDDA and/or better lubrication effect being achieved from DDDA.

It will be readily appreciated by those skilled in the art that various modifications to embodiments in accordance with the present disclosure may be devised without departing from the scope and teaching of the present teachings. It is to be understood that the scope of the claims appended hereto should not be limited by preferred embodiments disclosed herein, but should be given the broadest interpretation consistent with the description as a whole. It is also to be understood that the substitution of a variant of a any element or feature recited in a claim, without any substantial resultant change in functionality, will not constitute a departure from the scope of the claim.

In this patent document, any form of the word “comprise” is to be understood in its non-limiting sense to mean that any item following such word is included, but items not specifically mentioned are not excluded. A reference to an element by the indefinite article “a” does not exclude the possibility that more than one of the element is present, unless the context clearly requires that there be one and only one such element.

What is claimed is:

1. An aqueous drilling fluid composition comprising:
(a) water;
(b) one or more additives selected from the group consisting of viscosifiers, fluid loss control additives, weighting materials; and
(c) one or more di-functional carboxylic acids selected from the group consisting of butanedioic (succinic) acid, pentanedioic (glutaric) acid, hexanedioic (adipic) acid, heptanedioic (pimelic) acid, octanedioic (suberic) acid, nonanedioic (azelaic) acid, decanedioic (sebacic) acid, undecanedioic acid, dodecanedioic acid, tridecanedioic (brassylic acid), tetradecanedioic acid, pentadecanedioic acid, and hexadecanedioic (thapsic) acid.

2. An aqueous drilling fluid composition comprising:
(a) water;
(b) one or more additives selected from the group consisting of viscosifiers, fluid loss control additives, weighting materials; and
(c) dodecanedioic acid (DDDA).

3. An aqueous fluid composition as in claim 2, wherein the DDDA content in the drilling fluid composition is in the range between 3.5 and 6.6 kilograms per cubic meter.

4. An aqueous fluid composition as in claim 3, wherein the pH of the drilling fluid composition is in the range between 6.5 and 8.0.

5. The use of one or more di-functional carboxylic acids as additives in an aqueous drilling fluid, wherein the one or more di-functional carboxylic acids are selected from the group consisting of butanedioic (succinic) acid, pentanedioic (glutaric) acid, hexanedioic (adipic) acid, heptanedioic (pimelic) acid, octanedioic (suberic) acid, nonanedioic (azelaic) acid, decanedioic (sebacic) acid, undecanedioic acid, dodecanedioic acid, tridecanedioic (brassylic acid), tetradecanedioic acid, pentadecanedioic acid, and hexadecanedioic (thapsic) acid.

6. The use of dodecanedioic acid as an additive in an aqueous drilling fluid.
